(19) United States
(12) Patent Application Publication
(10) Pub. No.: US 2004/0184958 A1
(43) Pub. Date: Sep. 23, 2004

(54) Specimen centrifuge apparatus

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/766,873

(22) Filed: Jan. 30, 2004

(30) Foreign Application Priority Data
Jan. 31, 2003 (JP) 2003-024063

(51) Int. Cl. G01N 35/00; G01N 9/30

(52) U.S. Cl. 422/72; 422/101; 422/64; 422/65

(57) ABSTRACT

A specimen centrifuge apparatus includes a rotating disc having a plurality of slots arranged radially from a rotation axis of the rotating disc and specimen container buckets mounted in the slots. Each of the buckets is located such that a longitudinal direction of a container storing section of the bucket containing a plurality of tube-type specimen containers is set toward a radial direction of the rotating disc and shakably mounted such that a bottom of the container storing section is set in a circumferential direction of the rotating disc by centrifugal force caused when the rotation disc rotates.

### CROSS-REFERENCE TO RELATED APPLICATIONS

This application is based upon and claims the benefit of priority from the prior Japanese Patent Application No. 2003-024063, filed Jan. 31, 2003, the entire contents of which are incorporated herein by reference.

### BACKGROUND OF THE INVENTION

1. Field of the Invention

The invention relates to a specimen centrifuge apparatus for centrifuging a specimen such as blood.

2. Description of the Related Art

FIGS. 4 and 5 illustrate a prior art centrifuge apparatus. The prior art centrifuge apparatus is configured as follows. The centrifuge apparatus has a rotor RX having a rotating disc DX. A plurality of (four in this prior art) notches K are formed in the circumference of the rotating disc DX. Specimen container buckets BX are shakably arranged in their respective notches K such that their longitudinal directions are set toward the tangent to the rotating disc DX. The specimen container buckets BX each have container holders H. The container holders H hold tube-type specimen containers (test tubes) 1 containing specimens to be centrifuged, and are arranged in two lines each having five specimen containers 1. The rotating disc DX rotates about a rotating shaft SH at high speed to centrifuge the specimens. In FIGS. 4 and 5, an area DB circled by alternate long and short dashed lines shows the container holders H that are swung up in the radial direction of the rotor RX by the centrifugal force generated when the rotor RX rotates.

The above notches K can be replaced with a plurality of rectangular windows. The rectangular windows are formed in the circumference of a disc-shaped rotor. Test tube holders each serving as a specimen container bucket having a plurality of test tube insertion holes are shakably arranged in their respective rectangular windows such that their longitudinal directions are set toward the tangent to the disk-shaped rotor. Each of the test tube holders holds a test tube containing a specimen to be centrifuged, and the disk-shaped rotor rotates to centrifuge the specimen (see Japanese Patent Application KOKAI Publication No. 9-192539).

In the prior art specimen centrifuge apparatus, the specimen container buckets are arranged such that their longitudinal directions are set toward the tangent to the disk-shaped rotor. Thus, the axes of the tube-type specimen containers 1 held in the middle of each bucket exactly coincide with the radial direction of the rotor RX at the time of centrifuging, whereas, the axes of the tube-type specimen containers 1 held at both ends of each bucket do not exactly coincide with the radial direction. The centrifugal force in the radial direction of the rotor RX acts on the axial direction of the containers 1 held in the middle of each bucket and does not act on that of the containers 1 held at both ends of each bucket but on a direction slightly shifted from the axial direction. Consequently, when a blood specimen is centrifuged, the separation surface between serum and clot is inclined to the surface perpendicular to the axis of each specimen container 1.

If the centrifuged blood specimen exhibits the above phenomenon, there is fear that an automatic dispensing apparatus cannot absorb serum completely in order to aliquot and pipette the serum. There is also fear that the specimens in all specimen containers are not always centrifuged uniformly.

### BRIEF SUMMARY OF THE INVENTION

The invention is directed to a specimen centrifuge apparatus that substantially obviates one or more of the problems due to limitations and disadvantages of the related art.

According to an embodiment of the invention, a specimen centrifuge apparatus comprises a rotating disc having a plurality of slots arranged radially from a rotation axis of the rotating disc; and specimen container buckets mounted in the slots, each of the buckets being located such that a longitudinal direction of a container storing section of the bucket containing a plurality of tube-type specimen containers is set toward a radial direction of the rotating disc and being shakably mounted such that a bottom of the container storing section is set in a circumferential direction of the rotating disc by centrifugal force caused when the rotation disc rotates.

Additional objects and advantages of the invention will be set forth in the description which follows, and in part will be obvious from the description, or may be learned by practice of the invention.

The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention and, together with the general description given above and the detailed description of the embodiments given below, serve to explain the principles of the invention in which:

FIG. 1 is a schematic perspective view of a specimen centrifuge apparatus according to an embodiment of the invention;

FIG. 2 is a top view showing a rotor of the specimen centrifuge apparatus according to the embodiment of the invention;

FIG. 3 is a cross-sectional view taken along line III-III of FIG. 2;

FIG. 4 is a top view showing a rotor of a prior art specimen centrifuge apparatus; and

FIG. 5 is a cross-sectional view taken along line V-V of FIG. 4.

### DETAILED DESCRIPTION OF THE INVENTION

An embodiment of a specimen centrifuge apparatus according to the invention will now be described with reference to the accompanying drawings.

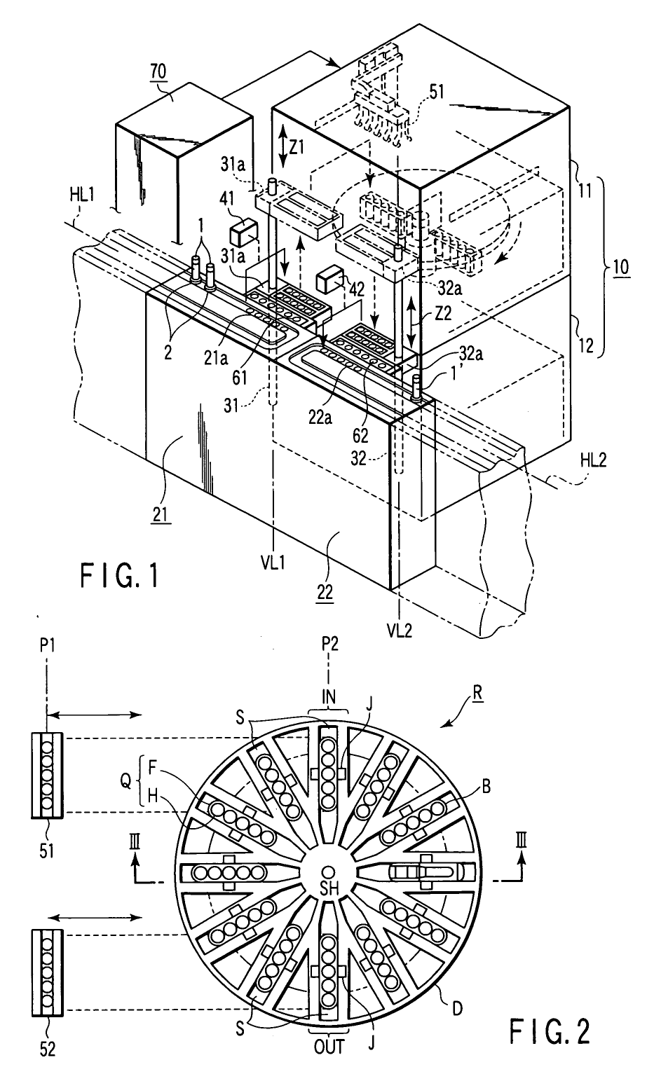

FIG. 1 illustrates a specimen centrifuge apparatus according to an embodiment of the invention. The specimen centrifuge apparatus comprises a centrifuge device 10 including a plurality of specimen centrifuge units 11 and 12 (two in the first embodiment). The specimen centrifuge units 11 and 12 are stacked one on another.

A carry-in conveyor 21 is provided along a horizontal conveyance line HL1 that passes by the centrifuge device 10. The carry-in conveyor 21 conveys a plurality of pre-process specimen containers 1 and has a belt-type conveyance lane formed to make a U-turn near the centrifuge device 10. The U-turn portion of the belt-type conveyance lane, which is close to the centrifuge device 10, has a container delivering section 21a. Thus, the specimen containers 1 such as test tubes are held by a holder 2 called a columnar rack and conveyed in the horizontal direction.

A carry-out conveyor 22 is provided along a horizontal conveyance line HL2 that passes by the centrifuge device 10. In the embodiment, the horizontal conveyance line HL2 is aligned with the horizontal conveyance line HL1. The carry-out conveyor 22 conveys a plurality of processed specimen containers 1′ and has a belt-type conveyance lane formed to make a U-turn near the centrifuge device 10. The U-turn portion of the belt-type conveyance lane, which is close to the centrifuge device 10, has a container receiving section 22a. Thus, the processed specimen containers 1′ such as test tubes are held by the holder 2 and conveyed in the horizontal direction.

A carry-in elevator 31 is provided in front of the centrifuge device 10 along a vertical conveyance line VL1 that passes by the specimen centrifuge units 11 and 12. The carry-in elevator 31 includes a specimen container rack 31a that stores a given number of (ten in this embodiment) pre-process specimen containers 1. Thus, the carry-in elevator 31 can convey the pre-process specimen containers 1, which are stored in the specimen container rack 31a, from a level of the container delivering section 21a of the carry-in conveyor 21 to a level of a designated one of the centrifuge units 11 and 12, as indicated by double-headed arrow Z1 in FIG. 1.

A carry-out elevator 32 is provided in front of the centrifuge device 10 along a vertical conveyance line VL2 that passes by the centrifuge units 11 and 12. The carry-out elevator 32 includes a specimen container rack 32a that stores a given number of (ten in this embodiment) processed specimen containers 1′. Thus, the carry-out elevator 32 can convey the processed specimen containers 1′, which are stored in the specimen container rack 32a, from a level of the container receiving section 22a of the carry-out conveyor 22 to a level of a designated one of the centrifuge units 11 and 12, as indicated by double-headed arrow Z2 in FIG. 1.

The carry-in and carry-out elevators 31 and 32 are exactly driven by a controller 70 such that their specimen container racks 31a and 32a can be opposed to the openings of the specimen centrifuge units 11 and 12, respectively.

A carry-in transfer arm (robot arm) 41 transfers the pre-process specimen containers 1 from the carry-in conveyor 21 to the carry-in elevator 31. A carry-out transfer arm (robot arm) 42 transfers the processed specimen containers 1′ from the carry-out elevator 32 to the carry-out conveyor 22.

The specimen centrifuge units 11 and 12 each have a loading arm 51. The loading arm 51 removes a pre-process specimen container 1 from the carry-in elevator 31 and loads it into one of the specimen centrifuge units 11 and 12.

The specimen centrifuge units 11 and 12 each have an unloading arm 52. The unloading arm 52 unloads a processed specimen container 1′ from one of the specimen centrifuge units 11 and 12 and moves it to the carry-out elevator 32. Reference numerals 61 and 62 denote a carry-in dummy rack and a carry-out dummy rack, respectively.

The specimen centrifuge units 11 and 12 can be operated independently. The controller 70 can control the specimen centrifuge units 11 and 12 simultaneously or selectively. The controller 70 can also control them such that the rotation direction of the rotor of each centrifuge can be set in a given direction.

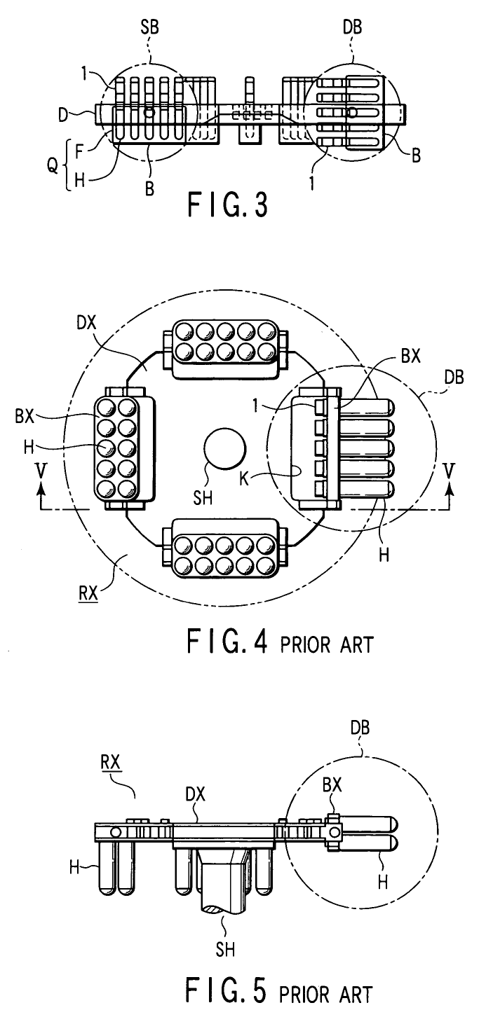

FIG. 2 is a top view of a rotor R of each of the specimen centrifuge units 11 and 12, and FIG. 3 is a cross-sectional view taken along line III-III of FIG. 2. The rotor R shown in FIGS. 2 and 3 has a rotating disc D. The rotating position of the rotating disc D can be set at a given angle by the controller 70 when the pre-process specimen containers 1 are carried in and the processed specimen containers 1′ are carried out. The rotating disc D can rotate at high speed at the time of centrifuging. A plurality of rectangular slots S are arranged radially from the rotating shaft SH of the rotating disc D. A hollow, rectangular parallelepiped specimen container bucket B is shakably mounted in each of the slots S such that its bottom is swung up in the radial direction of the disc D by centrifugal force when the rotation disc D rotates. In other words, the bucket B is supported at its middle part in its corresponding slot S through the rotation shaft J. The bucket B includes a container storing section Q. The container storing section Q has a hollow, rectangular parallelepiped frame F in which a plurality of (five in the embodiment) tube-type container holders H are attached such that the specimen containers 1 can be arranged in line. In FIG. 2, IN indicates a position in which a container is inserted and OUT denotes a position in which a container is removed.

An operation of the specimen centrifuge apparatus according to the embodiment will now be described.

The pre-process specimen containers 1 each containing a specimen to be centrifuged are held in the holder 2 and conveyed to the proximity of the centrifuge device 10 by the carry-in conveyor 21. The containers 1 stop when they reach the container delivering section 21a on the conveyance lane of the carry-in conveyor 21. The stopped containers 1 are removed five by five by the carry-in transfer arm 41 and arranged in two lines in the specimen container rack 31a attached to the carry-in elevator 31.

When the number of specimen containers 1 arranged in two lines in the specimen container rack 31 does not reach the prescribed number, or when the specimen containers 1 are not arranged five by five, a required number of dummy specimen containers, which are stocked in advance in the carry-in dummy rack 61, are removed and inserted in empty space of the rack 31a.

The carry-in elevator 31 conveys the ten specimen containers 1 arranged in the specimen container rack 31a to one of the specimen centrifuge units 11 and 12, which is designated by a host computer (not shown), for example, the specimen centrifuge unit 11 in the upper stage.

The specimen containers 1 conveyed to the upper specimen centrifuge unit 11 are sequentially carried into the centrifuge unit 11 by the carry-in arm 51 attached to the centrifuge device 10 and then loaded into the specimen container bucket B.

More specifically, five specimen containers 1 in the first line in the specimen container rack 31a are caught by a hand section of the carry-in arm 51 and removed therefrom as a vertical slide mechanism (not shown) goes up. The specimen containers 1 raised up to the upper limit by the vertical slide mechanism are slid from position P1 to position P2 by a horizontal slide mechanism 51a. When the vertical slide mechanism goes down, the specimen containers 1 are inserted into the specimen container bucket B set in the container inserting position IN (corresponding to position P2) of the rotor R. The hand section opens and thus the five specimen containers 1 are loaded into the specimen container bucket B.

Like the specimen containers 1 in the first line, five specimen containers 1 in the second line in the specimen container rack 31a are loaded into the specimen container bucket B by a series of operations of the carry-in arm 51. The specimen container bucket B for the containers 1 in the second line is located on the rotor R 180 degrees differently from that for the containers 1 in the first line.

In other words, the rotor of the centrifuge unit 11 rotates 180 degrees while the carry-in arm 51 is moving to catch the specimen containers 1 in the second line after the carry-in operation of the specimen containers 1 in the first line is completed. Thus, the specimen container bucket B, which is originally located in the position (corresponding to the container removing position OUT) which is 180 degrees different from the container inserting position IN, is set in the container inserting position IN. The specimen containers 1 in the second line are therefore inserted into the specimen container bucket B set in the container inserting position IN by the carry-in arm 51.

Repeating the above operation while varying the rotation angle of the rotor R slot S by slot S, the loading of specimen containers 1 into each bucket B of the rotor R of the specimen centrifuge unit 11 is completed. Then, the specimen centrifuge unit 11 starts to rotate to perform a centrifuge operation.

When the centrifuge operation is performed, each specimen container bucket B shifts from the state indicated by symbol SB to that indicated by symbol DB in FIG. 3. In other words, the bottom of the bucket is swung up in the radial direction from the axis of the rotating disc D. At this time, the axes of all the specimen containers 1 in the specimen container bucket B become parallel to the radial direction of the disc D, and the centrifugal force is exerted in the axial direction of the specimen container. When, for example, blood is centrifuged, the separation surface between serum and clot is at right angles to the axis of each specimen container 1. For this reason, when an automated dispensing apparatus sucks up serum, there is less fear that the serum remains.

When the centrifuge operation is completed by the specimen centrifuge unit 11, the carry-out arm 52 attached to the specimen centrifuge unit 11 sequentially removes the processed specimen containers 1′, the specimens of which are centrifuged in the specimen container bucket B located in the container removing position OUT of the rotor R corresponding to the position P2, in the order opposite to that of the above specimen container loading operation. Then, they are moved to the specimen container rack 32a attached to the carry-out elevator 32. The processed specimen containers 1′ are conveyed to level L0 of the container receiving section 22a of the carry-out conveyor 21 by the carry-out elevator 32. The processed specimen containers 1′ are then moved to the specimen container holder 2 of the carry-out conveyor 22 by the carry-out transfer arm 42. The dummy specimen containers are stored in the carry-out dummy rack 62. After that, they are returned to the carry-in dummy rack 61.

The above operation is repeated while varying the rotation angle of the rotor R slot by slot. As a result, all the specimen containers 1′ whose specimens are centrifuged by the specimen centrifuge unit 11 are moved to the specimen container holder 2 of the carry-out conveyor 22. The moved specimen containers 1′ are carried out by the carry-out conveyor 22. The one-cycle specimen centrifuge operation using the specimen centrifuge unit 11 is therefore completed.

The specimen centrifuge unit 12 in the lower stage performs the same operation as that of the specimen centrifuge unit 11 in the upper stage. The operation of carrying in the specimen containers 1 whose specimens are to be centrifuged by the centrifuge unit 12 can be performed any time during a period of time except when the operation of carrying in the specimen containers 1 whose specimens are to be centrifuged by the centrifuge unit 11.

The controller 70 drives the specimen centrifuge units 11 and 12 at the same time or drives a selected one of them.

The centrifuge operation of each of the centrifuge units 11 and 12 is performed for about five minutes at preset rotation speed (which is set such that the gravitational acceleration applied to the specimen containers 1 loaded into the rotating disc D having a given diameter becomes 2000 G).

When specimen containers are carried out of one of the specimen centrifuge units, e.g., the centrifuge unit 11, specimen containers 1 can quickly start to be carried into the other specimen centrifuge unit, e.g., the centrifuge unit 12. Accordingly, waiting time is shortened.

According to the embodiment of the invention, a specimen centrifuge apparatus comprises a rotor R including a rotating disc D having a plurality of slots S arranged radially from a rotation axis of the rotating disc D and specimen container buckets B mounted in the slots S, respectively. Each of the specimen container buckets B is located such that a longitudinal direction of a container storing section Q containing a plurality of tube-type specimen containers 1 is set toward a radial direction of the rotating disc D and each of the specimen container buckets B is shakably mounted such that a bottom of the container storing section is set in a circumferential direction of the rotating disc D by centrifugal force caused when the rotation disc D rotates.

In the specimen centrifuge apparatus described above, the axis of each of the tube-type specimen containers 1 is exactly set in the radial direction of the rotor R. The centrifugal force in the radial direction of the rotor R acts on the axial direction of all the specimen containers 1. The separation surface between the supernatant liquid (e.g., serum) and the remaining portion (e.g., clot) of a specimen that has been centrifuged is perpendicular to the axis of each of the specimen containers 1. Therefore, when an automatic dispensing apparatus absorbs specimens to aliquot and pipette the specimens, almost no supernatant liquid remains. Further, the container storing section Q includes a hollow, rectangular parallelepiped frame F having tube-type container holders which hold the tube-type specimen containers 1, respectively. The specimens in all specimen containers are uniformly centrifuged.

While the description above refers to particular embodiments of the invention, it will be understood that many modifications may be made without departing from the spirit thereof. The accompanying claims are intended to cover such modifications as would fall within the true scope and spirit of the invention. The presently disclosed embodiment is therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A specimen centrifuge apparatus comprising:
a rotating disc having a plurality of slots arranged radially from a rotation axis of the rotating disc; and
specimen container buckets mounted in the slots, each of the buckets being located such that a longitudinal direction of a container storing section of the bucket containing a plurality of tube-type specimen containers is set toward a radial direction of the rotating disc and being shakably mounted such that a bottom of the container storing section is set in a circumferential direction of the rotating disc by centrifugal force caused when the rotation disc rotates.

2. The specimen centrifuge apparatus according to claim 1, wherein the container storing section includes a hollow, rectangular parallelepiped frame having tube-type container holders which hold the tube-type specimen containers.
